(19) United States
(12) Patent Application Publication
(10) Pub. No.: US 2025/0039533 A1
(43) Pub. Date: Jan. 30, 2025

(54) IMAGE PICKUP APPARATUS, ITS CONTROL METHOD, AND STORAGE MEDIUM

(71) Applicant: CANON KABUSHIKI KAISHA, Tokyo (JP)

(72) Inventor: SHINICHI HAGIWARA, Tokyo (JP)

(21) Appl. No.: 18/766,084

(22) Filed: Jul. 8, 2024

(30) Foreign Application Priority Data
Jul. 28, 2023 (JP) 2023-122918

(51) Int. Cl. H04N 23/61; H04N 13/00; H04N 13/207; H04N 23/55; H04N 23/67

(52) U.S. Cl. CPC H04N 23/61; H04N 13/207; H04N 23/55; H04N 23/675; H04N 2013/0081

(57) ABSTRACT

An image pickup apparatus includes an imaging unit configured to photoelectrically convert a first optical image formed by a first optical system to output first image data, and to photoelectrically convert a second optical image formed by a second optical system arranged in parallel with the first optical system to output second image data, and a processor configured to determine a main object based on first object information in the first image data and second object information in the second image data.

### BACKGROUND

### Technical Field

One of the aspects of the embodiments relates to an image pickup apparatus, its control method, and a storage medium.

### Description of Related Art

Japanese Patent Laid-Open No. 2013-141052 discloses a camera that includes a lens unit having two optical systems and is configured to capture two images with parallax at once. In a case where the two optical systems are arranged to capture images in the same direction, an image in a 180-degree range (a half-sphere image) or a stereoscopically viewable image can be obtained from the two obtained images with parallax.

Japanese Patent Laid-Open No. 2001-222083 discloses an image pickup apparatus that performs autofocus (AF) in a case where a lens unit having two optical systems is attached, by changing a photometric or focus detecting area to an area that includes the vicinity of the center of at least one of two images with parallax.

During AF, an object may not be detected due to its orientation, angle, or sudden positional change, or an object may not be properly detected because an area unrelated to the object is detected, and the movement of the object cannot be accurately followed.

In particular, in using a lens unit having two optical systems arranged in parallel to each other, two optical images are formed on a single image sensor, so this is equivalent to imaging using half the size of the original image sensor. Thus, object detecting accuracy may be able to be lower than that in a case where a general monocular lens is attached.

### SUMMARY

An image pickup apparatus according to one aspect of the disclosure includes an imaging unit configured to photoelectrically convert a first optical image formed by a first optical system to output first image data, and to photoelectrically convert a second optical image formed by a second optical system arranged in parallel with the first optical system to output second image data, and a processor configured to determine a main object based on first object information in the first image data and second object information in the second image data. A control method for the above image pickup apparatus also constitutes another aspect of the disclosure. A computer-readable storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram illustrating an example of an overall configuration of an image pickup system according to each embodiment.

FIGS. 2A and 2B are external views of the image pickup apparatus according to each embodiment.

FIG. 3 is a block diagram of an image pickup apparatus according to each embodiment.

FIG. 4 is a configuration diagram of a lens apparatus according to each embodiment.

FIG. 5 explains captured images according to each embodiment.

FIG. 6 is a flowchart illustrating imaging processing according to each embodiment.

FIG. 7 is a flowchart illustrating main object determining processing according to a first embodiment.

FIG. 8 is a flowchart illustrating main object determining processing according to a second embodiment.

FIG. 9 is a flowchart illustrating noise determining processing according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,”” assembly,” “component,” or “device” may also refer to “circuit” with or without integration with packaging materials.

Referring now to the accompanying drawings, a detailed description will be given of embodiments according to the disclosure.

### First Embodiment

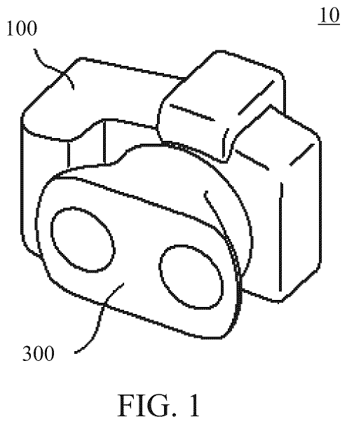

A description will now be given of a first embodiment according to the present disclosure. FIG. 1 is a schematic diagram illustrating an example of an overall configuration of an image pickup system 10 according to this embodiment. The image pickup system 10 includes a camera (image pickup apparatus) 100 and a lens unit (lens apparatus) 300 attachable to and detachable from the camera 100. Although details of the lens unit 300 will be described below, attaching the lens unit 300 enables the camera 100 to capture two images (still images or moving images) having a predetermined parallax at once.

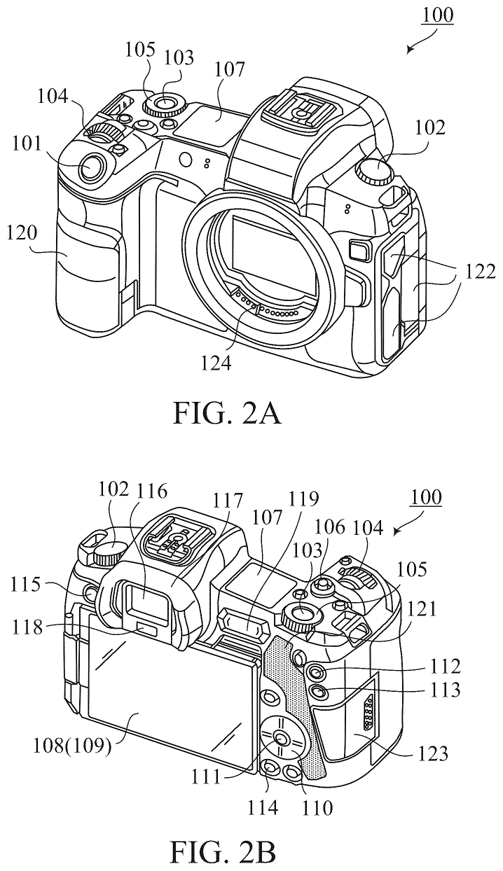

FIGS. 2A and 2B are external views illustrating an example of the camera 100. FIG. 2A is a perspective view of the camera 100 viewed from the front side, and FIG. 2B is a perspective view of the camera 100 viewed from the back side.

The camera 100 includes a shutter button 101, a power switch 102, a mode switch 103, a main electronic dial 104, a sub electronic dial 105, a moving image button 106, and an extra-finder (EF) display unit 107 on the top surface. The shutter button 101 is an operation member for issuing an imaging preparation instruction or an imaging instruction. The power switch 102 is an operation member that powers on and off the camera 100.

The mode switch 103 is an operation member for switching between various modes. The main electronic dial 104 is a rotary operating member for changing set values such as a shutter speed and an aperture value (F-number). The sub electronic dial 105 is a rotary operation member for moving a selection frame (cursor), forwarding an image, and the like. The moving image button 106 is an operation member for instructing to start or stop moving image capturing (recording). The extra-finder display unit 107 displays various setting values such as a shutter speed and an aperture value (F-number).

The camera 100 includes a display unit 108, a touch panel 109, a direction key 110, a setting button 111, an auto-exposure (AE) lock button 112, an enlargement button 113, a playback button 114, a menu button 115, an eyepiece unit 116, an eye proximity detector 118, and a touch bar 119 on the rear surface. The display unit 108 is a display unit configured to display an image and various information.

The touch panel 109 is an operation member configured to detect a touch operation on the display surface (touch operation surface) of the display unit 108. The direction key 110 is an operation unit including a key (four-direction key) that can be pressed in the up, down, left, and right directions. Processing can be performed according to the position where the direction key 110 is pressed. The setting button 111 is an operation member that is mainly pressed in order to determine a selection item. The AE lock button 112 is an operation member that is pressed to fix an exposure state in an imaging standby state.

The enlargement button 113 is an operation member for switching between turning on and turning off an enlargement mode in live-view display (LV display) in an imaging mode. In a case where the enlargement mode is turned on, the live-view image (LV image) is enlarged or reduced by operating the main electronic dial 104. The enlargement button 113 is used to enlarge a played image or increase an enlargement ratio in the enlargement mode.

The playback button 114 is an operation member for switching between the imaging mode and the playback mode. In the imaging mode, by pressing the playback button 114, the mode shifts to the playback mode, and the latest image among the images recorded on a recording medium 227, which will be described below, can be displayed on the display unit 108.

The menu button 115 is an operation member that is pressed to display a menu screen on the display unit 108 on which various settings can be made. The user can intuitively perform various settings using the menu screen displayed on the display unit 108, the direction key 110, and the setting button 111. The eyepiece unit 116 is a part of the eyepiece viewfinder (peep type viewfinder) 117 that the user approaches the eyepiece and peeps through it.

The user can visually recognize an image displayed on an Electronic View Finder (EVF) 217 inside the camera 100, which will be described below, through the eyepiece unit 116. The eye proximity detector 118 is a sensor that detects whether or not the user's eye is close to the eyepiece unit 116 (eyepiece viewfinder 117).

The touch bar 119 is a line-shaped touch operation member (line touch sensor) that can accept touch operations. The touch bar 119 is located at a position that is touch-operable (touchable) with the user's right thumb while the user grips the grip portion 120 with the right hand (right pinky finger, ring finger, and middle finger) so that the user's right index finger can press the shutter button 101. That is, the touch bar 119 can be operated in a state (imaging orientation) in which the user approaches the eyepiece viewfinder 117, peeps through the eyepiece unit 116, and is ready to press the shutter button 101 at any time.

The touch bar 119 can accept a tap operation to it (an operation of touching and then releasing the touch without moving the touch position within a predetermined period), a sliding operation to the left or right (an operation of moving the touch position after the user touches the touch bar 119), etc. The touch bar 119 is an operation member different from the touch panel 109 and does not have a display function. The touch bar 119 functions, for example, as a multi-function bar (M-Fn bar) to which various functions can be assigned.

The camera 100 also includes the grip portion 120, a thumb rest portion 121, terminal covers 122, a lid 123, a communication terminal 124, and the like. The grip portion 120 is a holder with a shape that is easy to grip with the user's right hand when the user holds the camera 100. While the user holds the camera 100 by gripping the grip portion 120 with his right little finger, ring finger, and middle finger, the shutter button 101 and the main electronic dial 104 are disposed at positions where they can be operated with the user's right index finger. In a similar state, the sub electronic dial 105 and the touch bar 119 are disposed at positions that can be operated with the user's right thumb.

The thumb rest portion 121 (thumb standby position) is a grip portion (or area) provided on the back side of the camera 100 at a location where the right thumb can be easily placed while gripping the grip portion 120 without operating any operating member. The thumb rest portion 121 is made of a rubber member or the like to increase the holding force (grip feeling). Terminal covers 122 protect connectors such as connection cables that connect the camera 100 to external devices (external apparatuses).

The lid 123 protects the recording medium 227 and a slot for storing the recording medium 227 by closing the slot, which will be described below. The communication terminal 124 is a terminal for communicating with a lens apparatus (such as a lens apparatus 200 described below or a lens apparatus 300 illustrated in FIGS. 1A and 1B) that is attachable to and detachable from the camera 100.

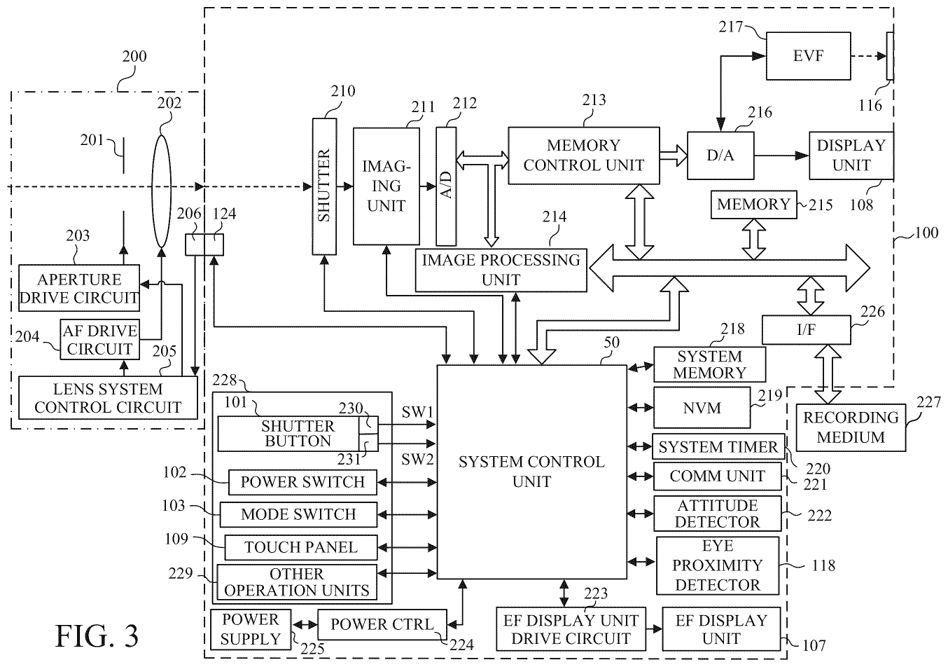

FIG. 3 is a block diagram illustrating an example of the configuration of the camera 100. Those elements, which are corresponding elements in FIG. 2, will be designated by the same reference numerals, and a description thereof will be omitted. FIG. 3 illustrates a state in which a lens unit (lens apparatus) 200 is attached to the camera 100.

A description will now be given of the lens apparatus 200. The lens apparatus 200 is one type of interchangeable lens attachable to and detachable from the camera 100. The lens apparatus 200 is a monocular lens, and is an example of a normal lens. The lens apparatus 200 includes an aperture stop (diaphragm) 201, a lens 202, an aperture drive circuit 203, an AF drive circuit 204, a lens system control circuit 205, a communication terminal 206, and the like.

The aperture stop 201 is configured to adjust an aperture diameter. The lens 202 includes a plurality of lenses. The aperture drive circuit 203 adjusts a light amount by controlling the aperture diameter in the aperture stop 201. The AF drive circuit 204 drives the lens 202 during focusing. The lens system control circuit 205 controls the aperture drive circuit 203, the AF drive circuit 204, etc. based on instructions from a system control unit (control unit) 50, which will be described below.

The lens system control circuit 205 controls the aperture stop 201 via the aperture drive circuit 203 and performs focusing by changing the position of the lens 202 via the AF drive circuit 204. The lens system control circuit 205 can communicate with the camera 100. More specifically, communication is performed via the communication terminal 206 of the lens apparatus 200 and the communication terminal 124 of the camera 100. The communication terminal 206 is a terminal through which the lens apparatus 200 communicates with the camera 100.

A description will now be given of the camera 100. The camera 100 includes a shutter 210, an imaging unit 211, an A/D converter 212, a memory control unit 213, an image processing unit 214, a memory 215, a D/A converter 216, an EVF 217, a display unit 108, and a system control unit 50.

The shutter 210 is a focal plane shutter that can freely control the exposure time of the imaging unit 211 based on instructions from the system control unit 50. The imaging unit 211 is an image sensor, such as a CCD and CMOS device, which converts an optical image into an electrical signal. The imaging unit 211 may include an imaging-surface phase-difference sensor that outputs defocus amount information to the system control unit 50. The A/D converter 212 converts the analog signal output from the imaging unit 211 into a digital signal. The A/D converter 212 may be built into the imaging unit 211.

The image processing unit 214 performs predetermined processing (pixel interpolation, resizing processing such as reduction, color conversion processing, etc.) for data from the A/D converter 212 or data from the memory control unit 213. The image processing unit 214 performs predetermined calculation processing using captured image data, and the system control unit 50 performs exposure control and distance measurement control based on the acquired calculation result. Through this processing, through-the-lens (TTL) type AF processing, auto-exposure (AE) processing, pre-flash emission (EF) processing, etc. are performed. The image processing unit 214 performs predetermined calculation processing using the captured image data, and the system control unit 50 performs TTL type auto white balance (AWB) processing based on the acquired calculation result.

Image data from the A/D converter 212 is written into the memory 215 via the image processing unit 214 and the memory control unit 213. Alternatively, image data from the A/D converter 212 is written into the memory 215 via the memory control unit 213 without using the image processing unit 214. The memory (storage unit) 215 stores image data obtained by the imaging unit 211 and converted into digital data by the A/D converter 212, and image data to be displayed on the display unit 108 and EVF 217. The memory 215 has a storage capacity sufficient to store a predetermined number of still images, a predetermined period of moving images, and audio. The memory 215 also serves as an image display memory (video memory).

The D/A converter 216 converts the image data for display stored in the memory 215 into an analog signal and supplies it to the display unit 108 and the EVF 217. Therefore, the image data for display written in the memory 215 is displayed on the display unit 108 and the EVF 217 via the D/A converter 216. The display unit 108 and EVF 217 perform display according to the analog signal from the D/A converter 216. The display unit 108 and the EVF 217 are, for example, display units such as an LCD or an organic EL display. The digital signal that has been A/D-converted by the A/D converter 212 and stored in the memory 215 is converted into an analog signal by the D/A converter 216, and is sequentially transferred to the display unit 108 or EVF 217 for display. Thereby, live-view display is performed.

The system control unit 50 is a control unit including at least one processor and/or at least one circuit. That is, the system control unit 50 may be a processor, a circuit, or a combination of a processor and a circuit. The system control unit 50 controls the camera 100 as a whole. The system control unit 50 executes programs recorded in a nonvolatile memory (NVM) 219 to realize each processing in the flowchart described below. The system control unit 50 also performs display control by controlling the memory 215, the D/A converter 216, the display unit 108, the EVF 217, and the like.

The camera 100 further includes a system memory 218, the nonvolatile memory 219, a system timer 220, a communication (COMM) unit 221, an attitude detector 222, and an eye proximity detector 118.

For example, a RAM is used as the system memory 218. Constants and variables for the operations of the system control unit 50, programs read out of the nonvolatile memory 219, and the like are loaded in the system memory 218. The nonvolatile memory 219 is electrically erasable/recordable memory, and for example, an EEPROM is used as the nonvolatile memory 219. The nonvolatile memory 219 records constants, programs, etc. for the operation of the system control unit 50. The program here is a program for executing a flowchart described below. The system timer 220 is a clock unit that measures the time used for various controls and the time of a built-in clock.

The communication unit 221 transmits and receives video signals and audio signals to and from external devices connected via wireless or wired cables. The communication unit 221 can also be connected to a wireless Local Area Network (LAN) and the Internet. The communication unit 221 can also communicate with external devices using Bluetooth (registered trademark) or Bluetooth (registered trademark) Low Energy. The communication unit 221 can transmit images captured by the imaging unit 211 (including live-view images) and images recorded on the recording medium 227, and can receive images and other various information from the external devices.

The attitude detector 222 detects the attitude (orientation) of the camera 100 relative to the gravity direction. Based on the attitude detected by the attitude detector 222, it is determined whether the image captured by the imaging unit 211 is an image captured with the camera 100 held horizontally or an image captured with the camera 100 held vertically. The system control unit 50 can add the attitude information according to the attitude detected by the attitude detector 222 to an image file of an image captured by the imaging unit 211, or rotate the image according to the detected attitude. For example, an acceleration sensor, a gyro sensor, or the like can be used for the attitude detector 222. Movement of the camera 100 (panning, tilting, lifting, whether it is stationary, etc.) can be detected using the attitude detector 222.

The eye proximity detector 118 can detect the proximity of an object to the eyepiece unit 116 (eyepiece viewfinder 117). For example, an infrared proximity sensor can be used as the eye proximity detector 118. In a case where an object approaches the eye proximity detector, infrared light emitted from a light projector in the eye proximity detector 118 is reflected by the object and is received by a light receiver of the infrared proximity sensor. The distance from the eyepiece unit 116 to the object can be determined based on the received infrared ray amount. Thus, the eye proximity detector 118 performs eye proximity detection to detect the proximity distance of an object to the eyepiece unit 116.

The eye proximity detector 118 is an eye proximity detection sensor that detects the approach and separation of the eye (object) from the eyepiece unit 116. In a case where an object is detected that approaches the eyepiece unit 116 within a predetermined distance from the non-proximity state, it is detected that the object is close to the eyepiece unit 116. On the other hand, in a case where the object whose approach was detected moves away from the proximity state (approach state) by a predetermined distance or more, it is detected that the eye has separated from the eye. A threshold for detecting the proximity and a threshold for detecting the separation may be different to provide hysteresis, for example. After the eye proximity is detected, the eye proximity is assumed unless eye separation is detected. After eye separation is detected, the eye separation state is assumed unless eye proximity is detected.

The system control unit 50 switches the display unit 108 and the EVF 217 between the display (display state) and non-display (non-display state) according to the state detected by the eye proximity detector 118. More specifically, in a case where the camera is at least in an imaging standby state and the display destination switching setting is automatically switchable, the display destination during non-eye proximity is set to the display unit 108, display of the display unit 108 is turned on and display of the EVF 217 is turned off. During eye proximity, the display destination is set to the EVF 217, the display of the EVF 217 is turned on, and display of the display unit 108 is turned off. The eye proximity detector 118 is not limited to an infrared proximity sensor, and another sensor may be used as long as it can detect a state that can be considered to be eye proximity.

The camera 100 further includes the extra-finder display unit 107, an extra-finder (EF) display drive circuit 223, a power control unit (CTRL) 224, a power supply unit 225, a recording medium interface (I/F) 226, an operation unit 228, and the like.

The extra-finder display unit 107 is driven by the extra-finder display drive circuit 223 and displays various setting values of the camera 100 such as a shutter speed and an aperture value. The power supply control unit 224 includes a battery detecting circuit, a DC-DC converter, a switch circuit for switching a block to which electricity is supplied, and the like, and detects whether or not a battery is attached, the type of battery, the remaining battery level, and the like. The power supply control unit 224 controls the DC-DC converter based on the detection result and the instruction from the system control unit 50, and supplies the necessary voltage to each unit including the recording medium 227 for a necessary period.

The power supply unit 225 is a primary battery such as an alkaline battery or a lithium battery, a secondary battery such as a NiCd battery, a NiNM battery, a Li battery, an AC adapter, or the like. The recording medium I/F 226 is an interface with the recording medium 227 such as a memory card or a hard disk drive. The recording medium 227 is a memory card or the like for recording captured images, and includes a semiconductor memory, a magnetic disk, or the like. The recording medium 227 may be removably attached to the camera 100 or may be built into the camera 100.

The operation unit 228 is an input unit that accepts operations from the user (user operations) and is used to input various instructions to the system control unit 50. The operation unit 228 includes the shutter button 101, the power switch 102, the mode switch 103, the touch panel 109, other operation units 229, and the like. The other operation units 229 include the main electronic dial 104, sub electronic dial 105, moving image button 106, direction key 110, setting button 111, AE lock button 112, enlargement button 113, playback button 114, menu button 115, touch bar 119, etc.

The shutter button 101 includes a first shutter switch 230 and a second shutter switch 231. The first shutter switch 230 is turned on when the shutter button 101 is half-pressed (instruction to prepare for imaging) during operation of the shutter button 101, and outputs first shutter switch signal SW1. The system control unit 50 starts imaging preparation processing such as AF processing, AE processing, AWB processing, and EF processing according to the first shutter switch signal SW1.

The second shutter switch 231 is turned on when the operation of the shutter button 101 is completed, or the shutter button 101 is so-called fully pressed (imaging instruction), and outputs the second shutter switch signal SW2. According to the second shutter switch signal SW2, the system control unit 50 starts a series of imaging processing from reading out signals from the imaging unit 211 to generating an image file containing the captured image and writing it into the recording medium 227.

The mode switch 103 switches the operation mode of the system control unit 50 to any one of still image capturing mode, moving image capturing mode, playback mode, etc. Modes included in the still image capturing mode include an automatic imaging mode, an automatic scene discrimination mode, a manual mode, an aperture priority mode (Av mode), a shutter speed priority mode (Tv mode), and a program AE mode (P mode). There are various scene modes, custom modes, etc. that provide imaging settings for each imaging scene.

The user can directly switch to any of the above imaging modes using the mode switch 103. The user can switch to the imaging mode list screen using the mode switch 103, and then selectively switch to any of the displayed modes using the operation unit 228. Similarly, the moving image capturing mode may also include a plurality of modes.

The touch panel 109 is a touch sensor that detects various touch operations on the display surface of the display unit 108 (the operation surface of the touch panel 109). The touch panel 109 and the display unit 108 can be integrated. For example, the touch panel 109 is attached to an upper layer of the display surface of the display unit 108 so that the light transmittance does not interfere with the display on the display unit 108. Associating the input coordinates on the touch panel 109 with the display coordinates on the display surface of the display unit 108 can form a graphical user interface (GUI) as if the user could directly operate the screen displayed on the display unit 108.

The touch panel 109 can use any one of various methods, such as a resistive film method, a capacitive method, a surface acoustic wave method, an infrared method, an electromagnetic induction method, an image recognition method, and an optical sensor method. Depending on the method, methods can be used that detect a touch when there is contact with the touch panel 109, and when a finger or pen approaches the touch panel 109, but any method can be used.

The system control unit 50 can detect the following operations or states on the touch panel 109:
A finger or a pen that has not touched the touch panel 109 newly touches the touch panel 109, that is, the start of a touch (referred to as Touch-down hereinafter);
A state in which the touch panel 109 is touched with a finger or a pen (referred to as Touch-on hereinafter);
A finger or pen that has touched the touch panel 109 moves away from the touch panel 109 (referred to as Touch-move hereinafter);
A finger or pen that has touched the touch panel 109 is removed from the touch panel 109 (released), that is, the touch ends (referred to as Touch-up hereinafter); and
A state in which nothing is touched on the touch panel 109 (referred to as Touch-off hereinafter).

In a case where Touch-down is detected, Touch-on is also detected at the same time. After Touch-down is made, Touch-on typically continues to be detected unless Touch-up is detected. In a case where Touch-move is detected, Touch-on is also detected at the same time. Even if Touch-on is detected, if the touch position does not move, Touch-move is not detected. After all touching fingers or pens are detected to have touched-up, Touch-off occurs.

These operations/states and the coordinates of the position where the finger or pen is touching on the touch panel 109 are notified to the system control unit 50 through the internal bus. The system control unit 50 determines what kind of operation (touch operation) has been performed on the touch panel 109 based on the notified information. Regarding touch movements, a moving direction of a finger or pen on the touch panel 109 can also be determined for each vertical component and horizontal component on the touch panel 109 based on changes in position coordinates. In a case where it is detected that a touch move has been made over a predetermined distance, it is determined that a slide operation has been performed.

A flick is an operation in which a finger touching the touch panel 109 quickly moves a certain distance, and then releases. In other words, the flick is an operation in which a finger is quickly traced on the touch panel 109 as if it flicks. In a case where Touch-move is detected over a predetermined distance and at a predetermined speed or higher, and Touch-up is detected as it is, it is determined that a flick has been performed (it can be determined that a flick has occurred following a slide operation). A pinch-in is a touch operation in which multiple points (such as two points) are touched together (multi-touch) and the touch positions are brought closer to each other, and a pinch-out is a touch operation in which the touch positions are moved away from each other. Pinch-out and pinch-in are collectively called a pinch operation (or simply pinch).

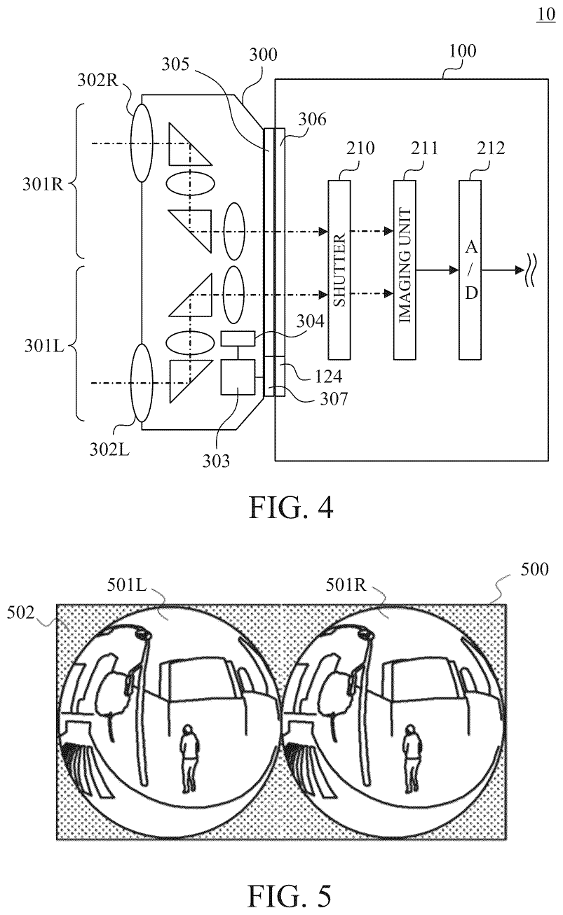

FIG. 4 is the configuration diagram of the lens apparatus 300. FIG. 4 illustrates a state in which the lens apparatus 300 is attached to the camera 100. In the camera 100 illustrated in FIG. 4, those elements, which are corresponding elements in FIG. 3, will be designated by the same reference numerals.

The lens apparatus 300 is a type of interchangeable lens that can be attached to and detached from the camera 100. The lens apparatus 300 includes a twin-lens (binocular lenses or two imaging optical systems) that can capture two images, i.e., a right image and a left image with parallax. In this embodiment, the lens apparatus 300 has two optical systems, and each of the two optical systems can image a wide field angle range of approximately 180 degrees. More specifically, each of the two optical systems of the lens apparatus 300 can capture an object at a field angle (angle of view) of 180 degrees in the horizontal direction (horizontal angle, azimuth angle, yaw angle) and 180 degrees in the vertical direction (vertical angle, elevation angle, pitch angle). In other words, each of the two optical systems can image a range of the front hemisphere.

The lens apparatus 300 includes a right-eye optical system 301R having a plurality of lenses, a mirror, etc., a left-eye optical system 301L having a plurality of lenses, a mirror, etc., a lens system control circuit 303, and an AF drive circuit 304. The left-eye optical system 301L is an example of a first optical system, and the right-eye optical system 301R is an example of a second optical system. However, this embodiment is not limited to this example, and the right-eye optical system 301R may be the first optical system, and the left-eye optical system 301L may be the second optical system. The right-eye optical system 301R has a lens 302R placed on the object side, and the left-eye optical system 301L has a lens 302L placed on the object side. The lens 302R and lens 302L face the same direction, and their optical axes are approximately parallel.

The lens system control circuit 303 controls the AF drive circuit 304 and the like. The lens system control circuit 303 focuses on the object by changing the positions of the right-eye optical system 301R and the left-eye optical system 301L via the AF drive circuit 304. In this embodiment, the AF drive circuit 304 controls the right-eye optical system 301R and the left-eye optical system 301L to associatively operate together. That is, focusing is made for the entire lens apparatus 300, and the focusing does not cause a focus shift between a right image and a left image. The focus shift between the right image and the left image can be finely adjusted by an unillustrated adjustment unit in FIG. 4, and can be adjusted in advance to the start of imaging.

The lens apparatus 300 is a binocular lens (VR180 lens) for obtaining a VR180 image, which is one of the formats of Virtual Reality (VR) images that enable binocular stereoscopic view. In this embodiment, the lens apparatus 300 has a fisheye lens capable of capturing a range of approximately 180 degrees in each of the right-eye optical system 301R and the left-eye optical system 301L. A capturable range by the lenses of each of the right-eye optical system 301R and the left-eye optical system 301L may be about 160 degrees, which is narrower than the 180-degree range.

The lens apparatus 300 allows a right image (first image) formed via the right-eye optical system 301R and a left image (second image) formed via the left-eye optical system 301L to be imaged onto one or two image sensors in the camera to which the lens apparatus 300 has been attached.

The lens apparatus 300 is attached to the camera 100 via a lens mount unit 305 and a camera mount unit 306 of the camera 100. Thus, the system control unit 50 of the camera 100 and the lens system control circuit 303 of the lens apparatus 300 are electrically connected via the communication terminal 124 of the camera 100 and the communication terminal 307 of the lens apparatus 300.

FIG. 5 explains captured images 500 acquired by the camera 100 according to this embodiment. In this embodiment, the right image formed via the right-eye optical system 301R and the left image formed via the left-eye optical system 301L are simultaneously (as a set) imaged on the imaging unit 211 in the camera 100. That is, two optical images formed by the right-eye optical system 301R and the left-eye optical system 301L are formed as an image 501R and a left image 501L, respectively, on an imaging surface 502 of a single image sensor.

The imaging unit 211 converts the formed object images (optical signals) into an electrical signal. Using the lens unit 300 in this way can simultaneously acquire (as a set) two images with parallax from two locations (optical systems): the right-eye optical system 301R and the left-eye optical system 301L. By dividing the acquired images into a left-eye image and a right-eye image and displaying it in VR, the user can view a stereoscopic VR image in a range of approximately 180 degrees.

As described above, the imaging unit 211 photoelectrically converts the first optical image formed by the left-eye optical system (first optical system) 301L to output first image data (left-eye image, left image). The imaging unit 211 also photoelectrically converts the second optical image formed by the right-eye optical system (second optical system) 301R to output second image data (right-eye image, right image).

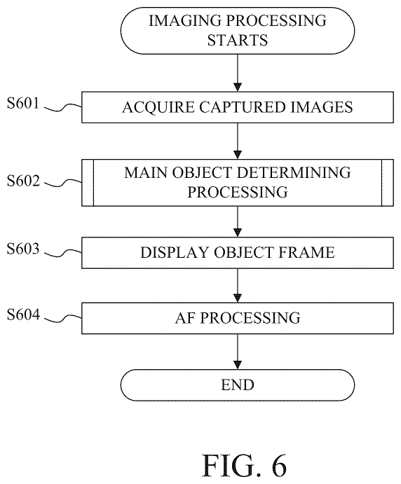

Referring now to FIG. 6, a description will be given of imaging processing by the image pickup system 10 according to this embodiment. FIG. 6 is a flowchart illustrating the imaging processing. First, in step S601, the system control unit 50 of the camera 100 acquires captured images using the attached lens unit 300. The images acquired in step S601 are two images (left image 501L, right image 501R) having two parallaxes for the same field of view formed on a single image sensor, similarly to the captured images 500 illustrated in FIG. 5.

Next, in step S602, the system control unit 50 determines a main object through main object determining processing based on the captured images 500 acquired in step S601. In this embodiment, the system control unit 50 determines the main object based on the object information (first object information) in the left image 501L and the object information (second object information) in the right image 501R.

The first object information includes, for example, information regarding whether an object (first object) is detected in the first image data, and information regarding a first evaluation value of the first object. Similarly, the second object information includes, for example, information regarding whether an object (second object) is detected in the second image data, and information regarding a second evaluation value of the second object. Details of the main object determining processing will be described below.

Next, in step S603, the system control unit 50 displays an object frame in the captured images 500 displayed on the display unit 108 for the main object determined in step S602. Thereby, the user can recognize which object in the captured images 500 is the object (main object) for AF processing.

For example, the system control unit 50 displays and superimposes a rectangular frame indicating the main object on the object area in the captured images 500 displayed on the display unit 108. Alternatively, for example, the system control unit 50 may assume that the object exists in both the left and right images (two images), display and superimpose a rectangular frame in the image in which the object has not been detected (one of the two images) at the same coordinate position as that in the image in which the object has been detected.

Next, in step S604, the system control unit 50 executes AF processing for the main object determined in step S602. This embodiment processes steps S603 and S604 in series, but is not limited to this example. In a case where the main object is determined in step S602, the processing in step S604 can be performed, so steps S603 and S604 may be processed in parallel.

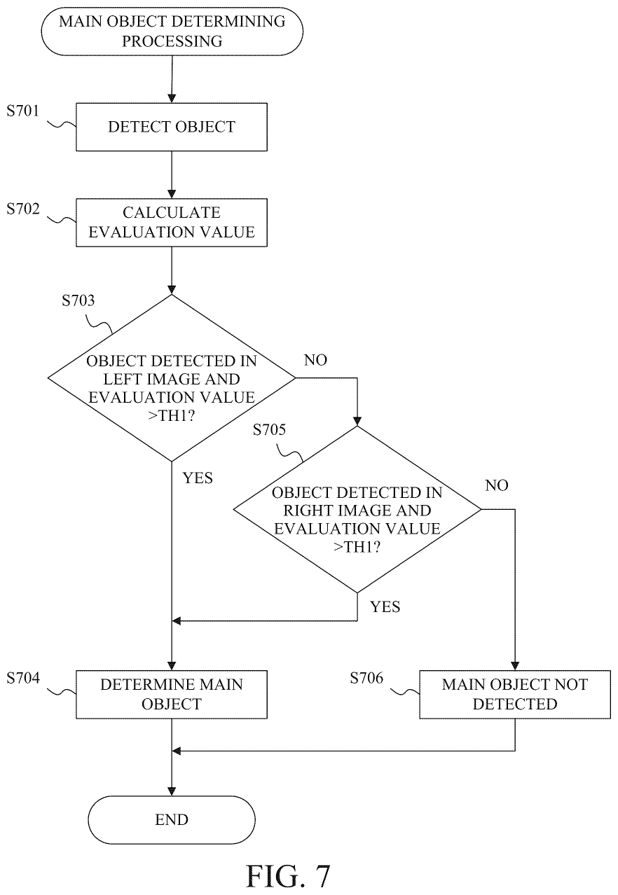

Referring now to FIG. 7, a detailed description will be given of the main object determining processing (step S602 in FIG. 6). FIG. 7 is a flowchart illustrating the main object determining processing. The main object determining processing prioritizes one of the right image 501R and left image 501L in the captured images 500 illustrated in FIG. 5 to set it as the main object, and set the object detected in the nonprioritized image to the main object only in a case where the object cannot be detected in the prioritized image.

Utilizing the fact that two, left and right, images of the same field of view have been acquired, even if the object cannot be detected in one of the images, the probability of detecting the same object can be increased by using the other image. In addition, the efficient object detecting processing can be performed by normally giving priority to the object detected in the prioritized image and using the nonprioritized image only in a case where the detection fails. Even in a case where there is a slight focal shift between the left and right lenses, priority is always given to one image, which suppresses fluctuations in the focus position during focusing on the same object and stabilizes AF processing accuracy.

This embodiment will discuss processing in which the left image 501L is a prioritized image and the right image 501R is a nonprioritized image, but is not limited to this example. The right image 501R may be set as a prioritized image, and the left image 501L may be set as a nonprioritized image, and similar processing can be applied.

First, in step S701, the system control unit 50 detects an object (object area) from the captured images acquired in step S601 of FIG. 6. At this point, object detection processing is performed for both the left and right images, regardless of whether it is the prioritized image or the nonprioritized image. The number of objects to be detected is not limited to one, and a plurality of objects may be detected.

Next, in step S702, the system control unit 50 calculates an evaluation value for at least one object area detected in step S701. For example, the system control unit 50 can set (calculate) the evaluation value by comparing it with a target to be compared, which has previously been registered in the camera 100, and by acquiring the degree of probability of the target to be compared. More specifically, a higher evaluation value is set for an object area with a higher probability. However, the method for calculating the evaluation value is not limited to this example, and various methods can be applied. As the target to be compared, one or more targets may be automatically selected from among people, animals, vehicles, etc., or the user may previously select them. For example, the target to be compared may be the object detected in the previous frame during imaging.

In and after step S703, processing is performed to determine whether the object detected in step S701 is the main object based on the evaluation value obtained in step S702 and a predetermined threshold (threshold TH1) previously set in the camera 100.

First, in step S703, the system control unit 50 determines whether or not an object (first object) has been detected in the left image (first image data), which is the prioritized image, and whether the evaluation value (first evaluation value) regarding that object becomes higher than the threshold (first threshold) TH1.

In a case where a plurality of objects are detected in the left image, the evaluation value of the object with the highest evaluation value acquired in step S702 is compared with the threshold TH1. In a case where it is determined that the evaluation value is higher than the threshold TH1, the flow proceeds to step S704. On the other hand, in a case where it is determined that the evaluation value is not higher than the threshold TH1, it is determined that no main object exists in the left image, and the flow proceeds to step S705.

In step S705, the system control unit 50 determines whether or not an object (second object) is detected in the right image (second image data) that is not the prioritized image, and whether the evaluation value (second evaluation value) regarding that object is higher than the threshold TH1. In a case where a plurality of objects are detected in the right image, the evaluation value of the object with the highest evaluation value acquired in step S702 is compared with the threshold TH1. In a case where it is determined that the evaluation value is higher than the threshold TH1, the flow proceeds to step S704. On the other hand, in a case where it is determined that the evaluation value is not higher than the threshold TH1, it is determined that no main object exists in the right image, and the flow proceeds to step S706.

In step S704, the system control unit 50 determines the object (first object or second object) selected in step S703 or S705 to be the main object. Then, the system control unit 50 stores, as main object information, information such as the coordinates of the object in the image and whether the object is detected in the left or right image, in a storage unit such as the memory 215, and uses it to associate it with the image and record it in metadata in storing the captured images. Thereby, object information can be utilized that has undergone AF processing during retouching after the images are captured.

In step S706, since no object has been detected in either the left image or the right image, the system control unit 50 determines that the main object was not detected (no main object has been detected).

Even if the object cannot be detected in the detecting processing using one of the two, left and right, images obtained by imaging with the same field of view, this embodiment performs the detecting processing using the other image and thereby suppresses failures in detecting processing for the same object.

### Second Embodiment

A description will now be given of a second embodiment according to the present disclosure. This embodiment specifically assumes an attempt to follow the same object in the previous and following frames during imaging, and changes a determining method according to a distance from the main object detecting coordinates in the previous frame in the main object determining processing. Those operations or steps in this embodiment, which are corresponding operations or steps in the first embodiment, will be designated by the same reference numerals, and a description thereof will be omitted.

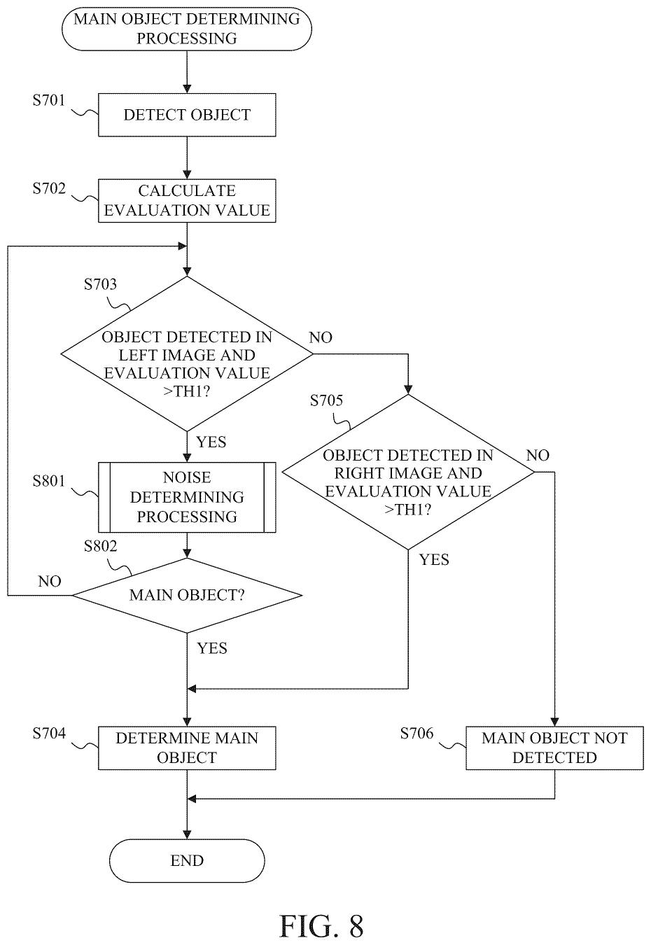

The main object determining processing according to this embodiment will be described with reference to FIG. 8. FIG. 8 is a flowchart illustrating main object determining processing according to this embodiment.

The main object determining processing according to this embodiment adds the following noise determining processing in step S801, in a case where an object with an evaluation value larger than the threshold (first threshold) TH1 is detected in step S703, before determining that object as the main object. That is, in a case where the system control unit 50 determines in step S703 that the first evaluation value regarding the first object is larger than the threshold TH, the system control unit 50 determines in step S801 whether or not the first object is noise.

In step S801, the system control unit 50 performs noise determining processing. Details of the noise determining processing will be described below.

Next, in step S802, the system control unit 50 determines whether the object determined to have an evaluation value larger than the threshold TH1 in step S703 is the main object, based on the determination result of the noise determining processing in step S801. That is, only when it is determined in step S802 that the object is the main object based on the determination result of the noise determining processing in step S801, the flow proceeds to step S704.

On the other hand, in a case where the object is determined to be noise in step S801, the system control unit 50 excludes the object determined to be noise from the main object candidate in step S802. In a case where a plurality of other objects are detected in the left image, the flow returns to step S703 for the object with the highest evaluation value among the remaining objects.

Such processing can restrain an object not to be followed from being erroneously detected as the main object, and improves the object detecting accuracy.

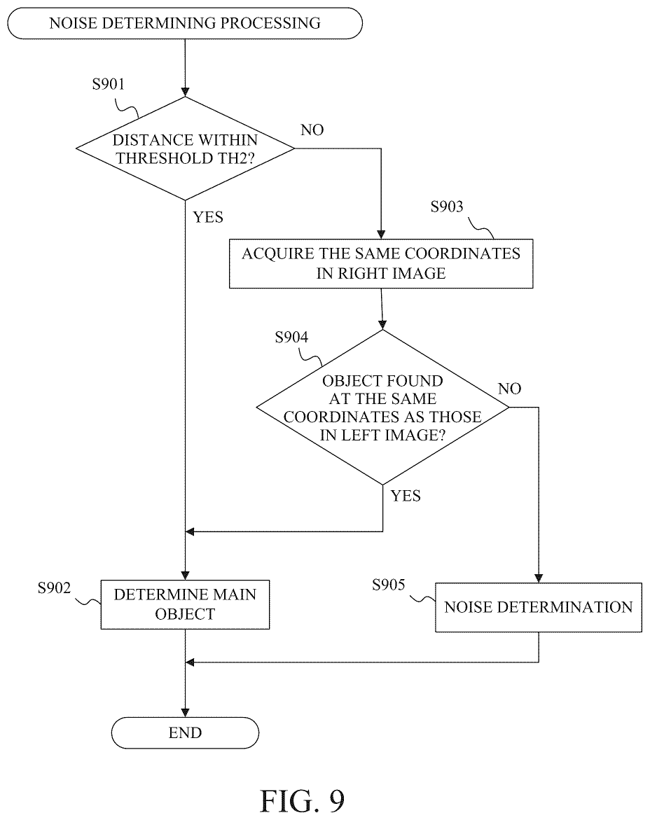

Referring now to FIG. 9, a detailed description will be given of the noise determining processing in step S801 in FIG. 8. FIG. 9 is a flowchart illustrating the noise determining processing.

First, in step S901, the system control unit 50 determines a distance between the detected position (coordinates) on the image of the object having the evaluation value larger than the threshold TH1 in step S703 of FIG. 8 and the position of the main object detected in the previous frame. Then, the system control unit 50 determines whether the distance between the object positions detected in the previous and following frames is within (smaller than) a threshold (second threshold) TH2. That is, the system control unit 50 determines whether or not the object is noise based on the distance between the first position of the object in the first frame (previous frame) of the left image, and the second position of the object in the second frame next to the first frame (following frame).

In a case where it is determined that the distance is within the threshold TH2, the flow proceeds to step S902. In step S902, the system control unit 50 determines that the object (first object) detected in step S703 is the main object. On the other hand, in a case where it is determined that the distance exceeds the threshold TH2, the flow proceeds to steps S903 and S904 to verify whether the object is noise.

In step S903, the system control unit 50 refers to the object position (coordinates) detected in the left image, and acquires an image area at the same position (same coordinates) in the right image.

Next, in step S904, the system control unit 50 determines whether or not the object detected in the left image exists in the image area in the right image acquired in step S903 (at the coordinates in the right image corresponding to the coordinates of the object in the left image). In a case where it is determined in step S904 that the same object exists at the same coordinates in the right image, it is determined that the object detected in the left image is not noise, and the flow proceeds to step S902.

On the other hand, in a case where it is determined in step S904 that the same object does not exist at the same coordinates in the right image, the flow proceeds to step S905. In step S905, the system control unit 50 determines that the object detected in the left image is not the object to be followed, but is accidentally detected noise.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide an image pickup apparatus that can more properly detect an object using a lens unit having two optical systems arranged in parallel with each other.

This application claims priority to Japanese Patent Application No. 2023-122918, which was filed on Jul. 28, 2023, and which is hereby incorporated by reference herein in its entirety.

What is claimed is:

1. An image pickup apparatus comprising:
an imaging unit configured to photoelectrically convert a first optical image formed by a first optical system to output first image data, and to photoelectrically convert a second optical image formed by a second optical system arranged in parallel with the first optical system to output second image data; and
a processor configured to determine a main object based on first object information in the first image data and second object information in the second image data.

2. The image pickup apparatus according to claim 1, wherein the processor is configured to perform autofocus processing for the main object.

3. The image pickup apparatus according to claim 1, wherein the first object information includes information regarding whether or not a first object is detected in the first image data, and information regarding a first evaluation value of the first object, and
wherein the second object information includes information regarding whether or not a second object is detected in the second image data, and information regarding a second evaluation value of the second object.

4. The image pickup apparatus according to claim 3, wherein the processor is configured to:
determine that the first object exists in the first image data in a case where it is determined that the first evaluation value is larger than a first threshold, and
determine that the second object exists in the second image data in a case where it is determined that the second evaluation value is larger than the first threshold.

5. The image pickup apparatus according to claim 3, wherein the processor is configured to determine the first object as the main object in a case where it is determined that the first evaluation value is larger than a first threshold.

6. The image pickup apparatus according to claim 3, wherein the processor is configured to determine whether the second evaluation value is larger than a first threshold in a case where it is determined that the first evaluation value is smaller than the first threshold.

7. The image pickup apparatus according to claim 6, wherein the processor is configured to determine the second object as the main object in a case where it is determined that the second evaluation value is larger than the first threshold.

8. The image pickup apparatus according to claim 6, wherein the processor is configured to determine that the main object is not detected in a case where it is determined that the second evaluation value is smaller than the first threshold.

9. The image pickup apparatus according to claim 3, wherein the processor is configured to determine whether or not the first object is noise in a case where it is determined that the first evaluation value is larger than a first threshold.

10. The image pickup apparatus according to claim 9, wherein the processor is configured to determine whether the first object is the noise based on a distance between a first position of the first object in a first frame of the first image data and a second position of the first object in a second frame next to the first frame.

11. The image pickup apparatus according to claim 10, wherein the processor is configured to determine that the first object is the main object in a case where it is determined that the distance is smaller than a second threshold.

12. The image pickup apparatus according to claim 10, wherein the processor is configured to determine whether the second object exists at a position corresponding to the second position in the second image data in a case where it is determined that the distance is larger than a second threshold.

13. The image pickup apparatus according to claim 10, wherein the processor is configured to:
determine that the second object is the main object in a case where it is determined that the second object exists at a position corresponding to the second position in the second image data, and
determine that the first object is the noise in a case where it is determined that the second object does not exist at the position corresponding to the second position in the second image data.

14. The image pickup apparatus according to claim 1, wherein the first image data and the second image data have parallax with each other.

15. The image pickup apparatus according to claim 1, the processor is configured to:
determine that an object having a highest evaluation value among a plurality of objects determined to exist in the first image data is the first object, and
determine that the object having the highest evaluation value among a plurality of objects determined to exist in the second image data is the second object.

16. The image pickup apparatus according to claim 1, wherein the processor is configured to display an area including the main object as a target for autofocus processing on a display unit.

17. The image pickup apparatus according to claim 1, wherein the processor is configured to store information regarding the main object in a memory in association with the first image data and the second image data.

18. A control method for an image pickup apparatus, the control method comprising the steps of:
acquiring first image data corresponding to a first optical image formed by a first optical system, and second image data corresponding to a second optical image formed by a second optical system arranged in parallel with the first optical system; and
determining a main object based on first object information in the first image data and second object information in the second image data.

19. A non-transitory computer-readable storage medium storing a program for causing a computer to execute the control method according to claim 18.
